(19) United States
(12) Patent Application Publication
(10) Pub. No.: US 2005/0084089 A1
(43) Pub. Date: Apr. 21, 2005

(54) Terminal device using a public switched telephone network

(75) Inventor: Ju-tak Yang, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/928,128

(22) Filed: Aug. 30, 2004

(30) Foreign Application Priority Data
Oct. 18, 2003 (KR) 2003-72805

(51) Int. Cl. H04M 3/42

(52) U.S. Cl. 379/211.02

(57) ABSTRACT

A terminal device using a PSTN includes a first line interface having at least four first connection terminals, one pair of the first connection terminals being connected to the PSTN and the other pair of the first connection terminals being connected to either the PSTN or an extended device, and a second line interface having at least four second connection terminals respectively connected in parallel to the first connection terminals. The second connection terminals are divided into two pairs of connection terminals, and if the other pair of the first connection terminals are connected to the extended device, one of one pair of the second connection terminals is connected to one of the other pair of the second connection terminals, and the other of one pair of the second connection terminals is connected to the other of the other pair of the second connection terminals to form jumpers.

### CROSS-REFERENCE TO RELATED APPLICATIONS

This application claims the benefit of Korean Patent Application No. 2003-72805, filed Oct. 18, 2003 in the Korean Intellectual Property Office, the disclosure of which is incorporated herein by reference in its entirety.

### BACKGROUND OF THE INVENTION

1. Field of the Invention

The present invention relates to a terminal device using a public switched telephone network (PSTN). More particularly, the present invention relates to a terminal device using a PSTN that can transmit/receive various kinds of data through the PSTN and can connect with extended devices using the PSTN.

2. Description of the Related Art

Throughout the world, various kinds of data are transmitted/received through a PSTN that is a kind of circuit switching telephone networks. However, different connection systems using the PSTN are used in different countries. That is, countries may briefly be classified into countries adopting a 2-wire system such as Korea and the United States, and countries adopting a 4-wire system such as Germany and Italy.

A terminal device used in a country adopting a 2-wire system (hereinafter referred to as a ‘terminal device adopting a 2-wire system’) is provided with two line interfaces such as modular jacks, and each line interface has four connection terminals (that is, second to fifth connection terminals). A facsimile may be an example of a terminal device adopting a 2-wire system or a 4-wire system. The third and fourth connection terminals of one line interface are connected to a PSTN, and the third and fourth connection terminals of the other line interface are connected to an extended device using a PSTN such as a telephone set and an automatic answering telephone set.

A terminal device used in a country adopting a 4-wire system (hereinafter referred to as a ‘terminal device adopting a 4-wire system’) is provided with one line interface, which has four connection terminals (that is, second to fifth connection terminals). The third and fourth connection terminals of the line interface are connected to a PSTN, and the second and fifth connection terminals are connected to an extended device using a PSTN. The second and third connection terminals are connected to each other, and the fourth and fifth connection terminals are connected to each other, so that various kinds of data input to the third and fourth connection terminals through the above-described connections could be transferred to an extended device using a PSTN that is connected to the second and fifth connection terminals.

As described above, since different connection systems connected with PSTNs are used in different countries, the line interfaces of the terminal devices adopting the 2-wire system and the 4-wire system should be manufactured in a different manner. If a user, who has purchased and used a terminal device adopting a 2-wire system, wanted to use a terminal device using a PSTN in a country adopting a 4-wire system, he/she would need to purchase a separate terminal device adopting a 4-wire system, thus bearing an additional expense.

Currently, in a country such as the United States, not only a service for providing one specified data through a line interface connected to a PSTN (hereinafter referred to as a ‘1-content service’), but also a service for providing two specified data (hereinafter referred to as a ‘2-content service’) is provided. A telephone service provided through a PSTN may be an example of the 1-content or 2-content service. The 2-content service receives one specified data through the third and fourth connection terminals of the line interface connected to the PSTN, and the other specified data through the second and fifth connection terminals. However, if the 2-content service is adopted into the existing terminal device adopting the 2-wire system, the third and fourth connection terminals and the second and fifth connection terminals are connected together to form a loop, and thus the telephone line is recognized to be busy all the time.

### SUMMARY OF THE INVENTION

An aspect of the present invention is to provide a terminal device using a PSTN that can be generally adopted into different PSTN connection systems in different countries and that can be efficiently adopted into a 2-content service as well.

To achieve the above aspects and/or other features of the present invention, there is provided a terminal device using a PSTN connected to one or more extended devices using the PSTN, the terminal device comprising a first line interface having at least four first connection terminals, one pair of the first connection terminals being connected to the PSTN and the other pair of the first connection terminals being connected to either of the PSTN or the extended device, and a second line interface having at least four second connection terminals respectively connected in parallel to the first connection terminals. The second connection terminals are divided into two pairs of connection terminals, and if the other pair of the first connection terminals are connected to the extended device, one of one pair of the second connection terminals is connected to one of the other pair of the second connection terminals, and the other pair of the second connection terminals is connected to the other of the other pair of the second connection terminals.

If the other pair of the first connection terminals is connected to the PSTN, more than one extended device may be connectable to one pair of the second connection terminals and to the other pair of the second connection terminals.

In another aspect of the present invention, the terminal device further includes a first connection unit, provided between one of one pair of the second connection terminals and one of the other pair of the second connection terminals, for performing either of opening and shorting the corresponding connection terminals, and a second connection unit, provided between the other of one pair of the second connection terminals and the other of the other pair of the second connection terminals, for performing either of opening and shorting the corresponding connection terminals. If the other pair of the first connection terminals is connected to the extended terminals, the first and second connection units are in a short state.

If the other pair of the first connection terminals is connected to the PSTN, the first and second connection units are in an open state, and more than one extended device is connectable to one pair of the second connection terminals and to the other pair of the second connection terminals.

In another aspect of the present invention, there is provided a terminal device using a PSTN connected to one or more extended devices using the PSTN, the terminal device comprising a first line interface having at least four first connection terminals, one pair of the first connection terminals and the other pair of the first connection terminals being respectively connected to the PSTN, and a second line interface having at least four second connection terminals respectively connected in parallel to the first connection terminals. By connecting one pair of the second connection terminals to one of the extended devices and connecting the other pair of the second connection terminals to the other of the extended devices, specified contents are transmitted from the PSTN to the respective extended devices through the one pair of the first connection terminals and the other pair of the first connection terminals.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a terminal device using a PSTN that receives a 2-content service from a PSTN in a country adopting a 2-wire system according to an embodiment of the present invention;

FIG. 2 is a block diagram illustrating the terminal device of FIG. 1 that is adopted into a PSTN in a country adopting a 4-wire system;

FIG. 3 is a block diagram illustrating a terminal device using a PSTN that receives a 2-content service from a PSTN in a country adopting a 2-wire system according to another embodiment of the present invention; and

FIG. 4 is a block diagram illustrating the terminal device of FIG. 3 that is adopted into a PSTN in a country adopting a 4-wire system.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

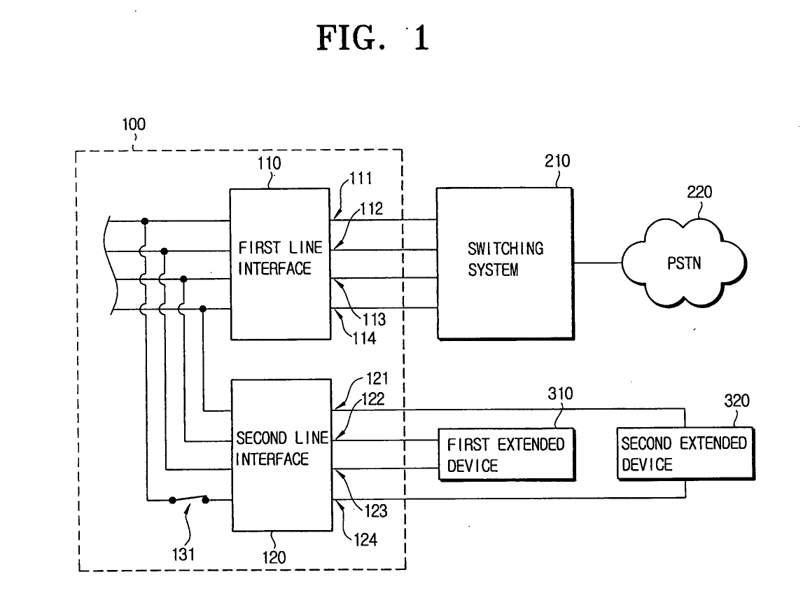

FIG. 1 is a block diagram illustrating a terminal device using a PSTN that receives a 2-content service from the PSTN in a country adopting a 2-wire system according to an embodiment of the present invention. A facsimile is used as a terminal device using a PSTN, by way of example, but is not limited to these embodiments.

Referring to FIG. 1, a facsimile 100 includes a first line interface 110 and a second line interface 120. The first line interface 110 has four connection terminals, that is, a (1-2)-th connection terminal 111, a (1-3)-th connection terminal 112, a (1-4)-th connection terminal 113, and a (1-5)-th connection terminal 114. The connection terminals 111 through 114 are connected to a PSTN 220 through a switching system 210 to transmit/receive specified data such as audio data. If a 1-content service is provided, specified data is provided through the (1-3)-th and (1-4)-th connection terminals 112 and 113. If a 2-content service is provided, one specified data is provided through the (1-3)-th and (1-4)-th connection terminals 112 and 113, and the other specified data is provided through the (1-2)-th and (1-5)-th connection terminals 111 and 114. The respective connection terminals 111 through 114 are connected to various kinds of device-related units in the facsimile 100, such as a control unit (not shown). Hereinafter, lines connected to the (1-2)-th through (1-5)-th connection terminals 111, 112, 113, and 114 are called (1-2)-th through (1-5)-th lines.

The second line interface 120 has four connection terminals, that is, a (2-2)-th connection terminal 121, a (2-3)-th connection terminal 122, a (2-4)-th connection terminal 123, and a (2-5)-th connection terminal 124. The connection terminals 121 though 124 are connected to extended devices using a PSTN such as a telephone set and an automatic answering telephone set, to transmit/receive specified data such as audio data. If a 1-content service is provided, the (2-3)-th and (2-4)-th connection terminals 122 and 123 are connected to the extended devices (not shown) using a PSTN, and if a 2-content service is provided, the (2-3)-th and (2-4)-th connection terminals 122 and 123 are connected to a first extended device 310 using a PSTN, and the (2-2)-th and (2-5)-th connection terminals 121 and 124 are connected to a second extended device 320 using a PSTN. Hereinafter, lines connected to the (2-2)-th through (2-5)-th connection terminals 121, 122, 123, and 124 are called (2-2)-th to (2-5)-th lines.

The first line interface 110 and the second line interface 120 are connected to each other in the facsimile 100. Specifically, the (1-2)-th line through (1-5)-th line are connected to the (2-5)-th line through (2-2)-th line at specified nodes, respectively, and through the lines, the first line interface 110 and the second line interface 120 are connected in parallel.

On at least one line among the (2-2)-th line and the (2-5)-th line, a relay switch 131 is provided. As shown in FIG. 1, the relay switch 131 is provided on the (2-5)-th line, but the present invention is not limited to this embodiment. The relay switch 131 switches to a turned-off state if the 1-content service is provided, and to a turned-on state if the 2-content service is provided. For example if it is sensed by a hook-off sensing unit (not shown) that the second extended device, which is an extended device using a PSTN, is in a hook-off state, the corresponding information is transmitted to the control unit (not shown), and the control unit controls the relay switch 131 to turn on based on the information. Through the above-described process, the 2-content service for providing contents to both the first extended device 310 and the second extended device 230 is provided.

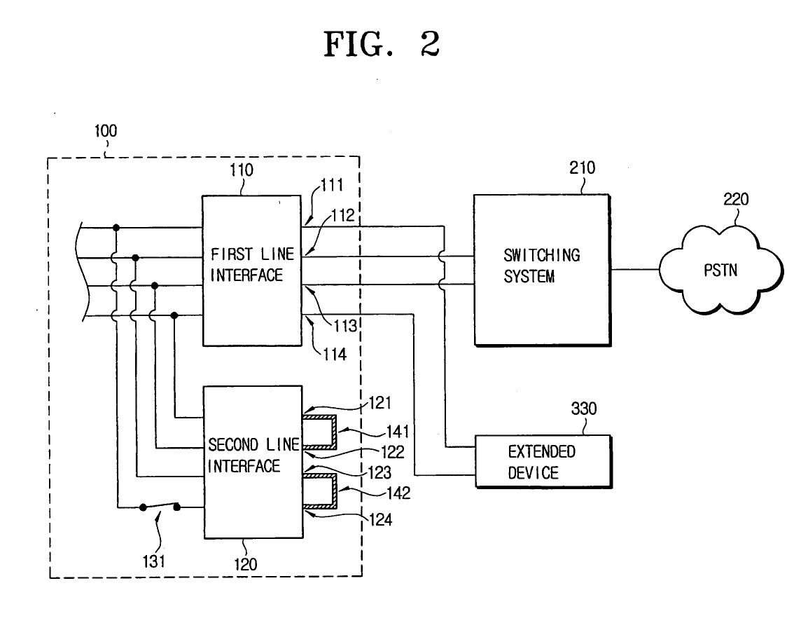

FIG. 2 is a block diagram illustrating the terminal device of FIG. 1 that is adopted into a PSTN in a country adopting a 4-wire system. The (1-3)-th and (1-4)-th connection terminals 112 and 113 of the first line interface 110 are connected to the PSTN 220 through the switching system 210, and the (1-2)-th and (1-5)-th connection terminals 111 and 114 of the first line interface 110 are connected to an extended device 330. Also, the relay switch 131 is set to a turned-on state when it is used in a country adopting a 4-wire system.

As described above, in a country adopting a PSTN using a 4-wire system, because the (1-2)-th and (1-3)-th connection terminals 111 and 112 and the (1-4)-th and (1-5)-th connection terminals 113 and 114 of the first line interface 110 should be connected to each other, a first dummy jack 141, or jumper, is mounted on the (2-2)-th and (2-3)-th connection terminals 121 and 122 of the second line interface 120, and a second dummy jack 142 is mounted on the (2-4)-th and (2-5)-th connection terminals 123 and 124 of the second line interface 120.

The specified data input through the (1-3)-th connection terminal 112 is applied to the second dummy jack 142 through the (1-3)-th line and the (2-4)-th line, and then to the extended device 330 through the (2-5)-th line and the (1-2)-th line. At the same time, the specified data input through the (1-4)-th connection terminal 113 is applied to the first dummy jack 141 through the (1-4)-th line and the (2-3)-th line, and then to the extended device 330 through the (2-2)-th line and the (1-5)-th line. Accordingly, the same result as an existing terminal device adopting a 4-wire system and having one line interface can be obtained.

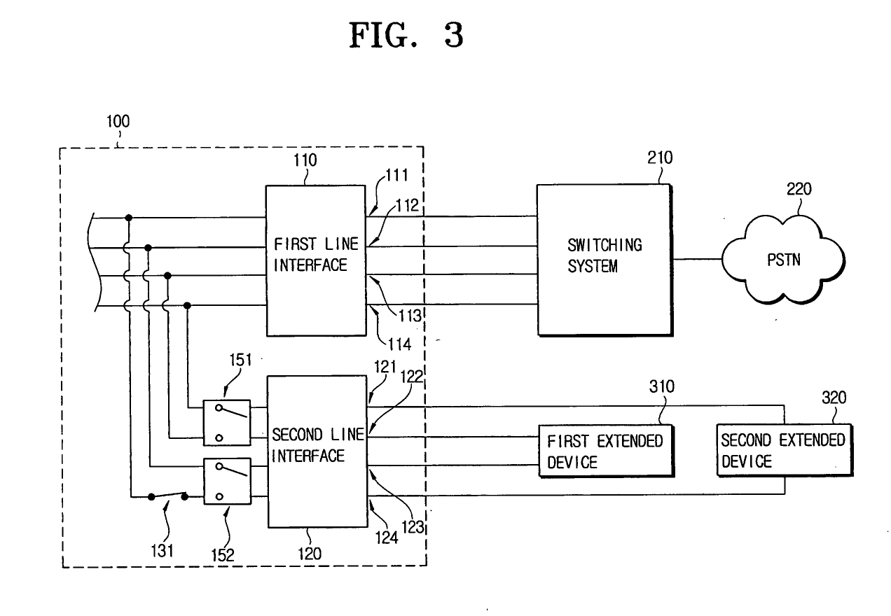

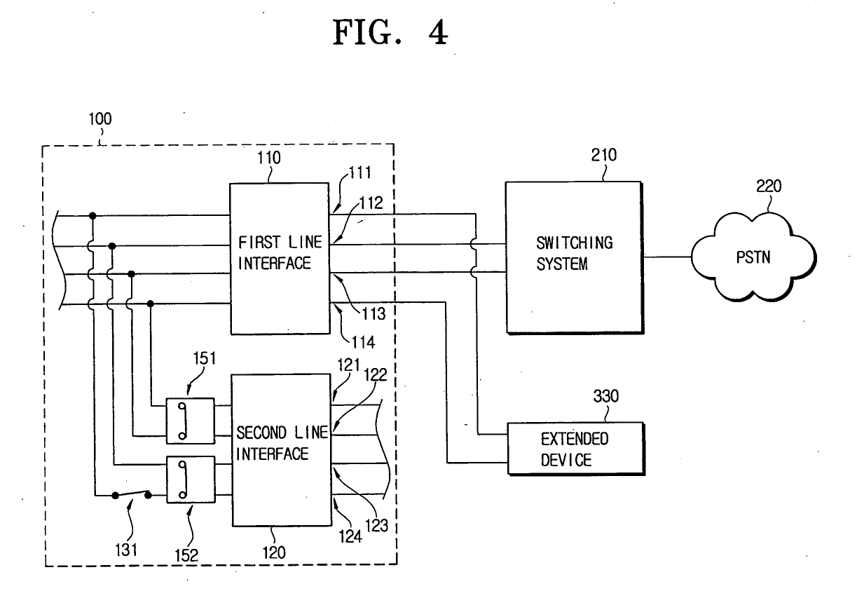

FIG. 3 is a block diagram illustrating a terminal device using a PSTN that receives a 2-content service from a PSTN in a country adopting a 2-wire system according to another embodiment of the present invention, and FIG. 4 is a block diagram illustrating the terminal device of FIG. 3 that is adopted into a PSTN in a country adopting a 4-wire system.

The difference between the embodiment of FIGS. 3 and 4 and that of FIGS. 1 and 2 is that a first switch 151 is connected between the (2-2)-th line and the (2-3)-th line, and a second switch 152 is connected between the (2-4)-th line and the (2-5)-th line. It may also be possible that the first switch 151 is connected between the (2-2)-th and (2-3)-th connection terminals 121 and 122 of the second line interface 120 which is connected to one or more extended devices, and the second switch 152 is connected between the (2-4)-th and (2-5)-th connection terminals 123 and 124.

According to the embodiment of the present invention, as shown in FIG. 3, the first and second switches 151 and 152 are turned off in a country adopting a 2-wire system. Accordingly, a pair of specified data input through the (1-3)-th and (1-4)-th connection terminals 112 and 113 of the first line interface 110 are applied to the (2-4)-th connection terminal 123 through the (1-3)-th line and the (2-4)-th line and to the (2-3)-th connection terminal 122 through the (1-4)-th line and the (2-3)-th line, respectively. The specified data on the (2-4)-th and (2-3)-th connection terminals 123 and 122 are input to the first extended device 310. A pair of specified data input through the (1-2)-th and (1-5)-th connection terminals 111 and 114 are applied to the (2-5)-th connection terminal 124 through the (1-2)-th line and the (2-5)-th line and to the (2-2)-th connection terminal 121 through the (1-5)-th line and the (2-2)-th line, respectively. The specified data on the (2-5)-th and (2-2)-th connection terminals 124 and 121 are input to the second extended device 320. Accordingly, the (1-3)-th and (1-4)-th connection terminals 112 and 113 of the first line interface 110 are not connected with the (2-2)-th and (2-5)-th connection terminals 121 and 124 of the second line interface 120 to form a loop.

As shown in FIG. 4, the first and second switches 151 and 152 are turned on in a country adopting a 4-wire system. Accordingly, specified data input through the (1-3)-th connection terminal 112 is applied to the second switch 152 through the (1-3)-th and (2-4)-th lines. The specified data input to the second switch 152 is input to the extended device 330, which is connected to the (1-2)-th connection terminal 111, through the (2-5)-th and (1-2)-th lines. Specified data input through the (1-4)-th connection terminal 113 is applied to the first switch 151 through the (1-4)-th and (2-3)-th lines and is input to the extended device 330, which is connected to the (1-5)-th connection terminal 114, through the first switch 151, the (2-2)-th and (1-5)-th lines. Accordingly, the same result as an existing terminal device adopting a 4-wire system can be obtained.

In the embodiments of the present invention, the first and second switches 151 and 152 may be constructed in a manner that a user can manually turn on and off the first and second switches 151 and 152. Meanwhile, the first and second switches 151 and 152 may also be constructed in a manner that when a selection command for selecting a country adopting a 2-wire system or a 4-wire system is input through an input unit (not shown), the control unit (not shown) controls the first and second switches 151 and 152 to be turned off in a country adopting a 2-wire system, while it controls the first and second switches 151 and 152 to be turned on in a country adopting a 4-wire system.

As described above, according to the terminal device using a PSTN of the present invention, it is not required for a manufacturer to manufacture separate terminal devices in different countries. Accordingly, it is not required to provide a dual manufacturing process, and thus the manufacturing cost can be reduced.

Also, it is not required for a consumer to purchase separate terminal devices in different countries, but it is possible to generally use the terminal device in different countries, and thus the consumer's expense can be reduced.

Although a few embodiments of the present invention have been shown and described, it would be appreciated by those skilled in the art that changes may be made in this embodiment without departing from the principles and spirit of the invention, the scope of which is defined in the claims and their equivalents.

1. A terminal device using a public switched telephone network (PSTN) connected to at least one extended device using the PSTN, comprising:
a first line interface having at least four first connection terminals, one pair of the first connection terminals being connected to the PSTN, and an other pair of the first connection terminals being connected to either the PSTN or the extended device; and
a second line interface having at least four second connection terminals respectively connected in parallel to the first connection terminals,
wherein the second connection terminals are divided into two pairs of connection terminals corresponding to the one pair and the other pair of the first connection terminals, and if the other pair of the first connection terminals are connected to the extended device, one of one pair of the second connection terminals is connected to one of the other pair of the second connection terminals, and the other one of the one pair of the second connection terminals is connected to the other one of the other pair of the second connection terminals.

2. The terminal device as claimed in claim 1, wherein, if the other pair of the first connection terminals is connected to the PSTN, the at least one extended device is connectable to one pair of the second connection terminals and to the other pair of the second connection terminals.

3. The terminal device as claimed in claim 1, further comprising:
a first connection unit provided between one of one pair of the second connection terminals and one of the other pair of the second connection terminals, for performing either opening or shorting the corresponding connection terminals; and
a second connection unit provided between the other of one pair of the second connection terminals and the other of the other pair of the second connection terminals, for performing either opening or shorting the corresponding connection terminals,
wherein, if the other pair of the first connection terminals is connected to the at least one extended device, the first and second connection units are in a short state.

4. The terminal device as claimed in claim 3, wherein, if the other pair of the first connection terminals is connected to the PSTN, the first and second connection units are in an open state, and the at least one extended device is connectable to the one pair of the second connection terminals and to the other pair of the second connection terminals.

5. The terminal device as claimed in claim 3, wherein at least one of the first and second connection units is a detachable dummy jack, and the opening corresponds to a detachment of the dummy jack, and the shorting corresponds to a mounting of the dummy jack.

6. The terminal device as claimed in claim 4, wherein at least one of the first and second connection units is a detachable dummy jack, and the opening corresponds to a detachment of the dummy jack, and the shorting corresponds to a mounting of the dummy jack.

7. The terminal device as claimed in claim 3, wherein at least one of the first and second connection units is a switch, and the opening corresponds to a turning-off of the switch, and the shorting corresponds to a turning-on of the switch.

8. The terminal device as claimed in claim 4, wherein at least one of the first and second connection units is a switch, and the opening corresponds to a turning-off of the switch, and the shorting corresponds to a turning-on of the switch.

9. The terminal device as claimed in claim 1, wherein the terminal device is a facsimile.

10. The terminal device as claimed in claim 1, wherein the one or more extended device is at least one of a telephone set and an automatic answering telephone set.

11. A terminal device using a public switched telephone network (PSTN) connected to one or more extended devices using the PSTN, the terminal device comprising:
a first line interface having at least four first connection terminals, one pair of the first connection terminals and an other pair of the first connection terminals being connected to the PSTN; and
a second line interface having at least four second connection terminals respectively connected in parallel to the first connection terminals,
wherein, by connecting one pair of the second connection terminals to one of the extended devices and connecting the other pair of the second connection terminals to the other of the extended devices, specified contents are transmitted from the PSTN to the respective extended devices through the one pair of the first connection terminals and the other pair of the first connection terminals.

12. The terminal device as claimed in claim 11, wherein the terminal device is a facsimile.

13. The terminal device as claimed in claim 11, wherein the one or more extended device is at least one of a telephone set and an automatic answering telephone set, and the specified contents are audio data.

14. A universal interface for a public switched telephone network (PSTN) terminal device, comprising:
a first line interface connectable to either the PSTN or the PSTN and a first extended device;
a second line interface which connects in parallel with the first line interface by data lines; and
a switching unit which selectively connects the data lines in the second line interface,
wherein when the first line interface is connected to the PSTN and the first extended device, the switching unit connects the data lines in the second line interface to create data paths from the PSTN to the extended device through the first line interface and the second line interface, and when the first line interface is connected to the PSTN, the switching unit is turned off to allow the data paths to pass through the second line interface.

15. The universal interface as claimed in claim 14, wherein the first line interface is connected to the PSTN and the first extended device in a 4-wire PSTN system.

16. The universal interface as claimed in claim 14, wherein the first line interface is connected to the PSTN in a 2-wire PSTN system.

17. The universal interface as claimed in claim 14, wherein the switching unit is manually controllable by a user based on whether the PSTN is a 2-wire or a 4-wire system.

18. The universal interface as claimed in claim 17, wherein the switching unit comprises jumpers which are manually set to connect data lines in the second line interface.

19. The universal interface as claimed in claim 14, wherein the switching unit automatically connects the data lines of the second line interface based on whether the PSTN is a 2-wire or a 4-wire system.

20. The universal interface as claimed in claim 14, further comprising a relay switch selectively switching at least one of the data lines in the second line interface based on a type of the PSTN.

21. The universal interface as claimed in claim 20, wherein when the PSTN is 2-wire 1 content service a second extended device is connected to the second line interface by a first pair of the data lines and the relay switch turns off unused data lines.

22. The universal interface as claimed in claim 20, wherein when the PSTN is 2-wire 2 content service the second extended device is connected to the second line interface by a first pair of the data lines and a third extended device is connected to the second line interface by a second pair of data lines and the relay switch is turned on.

23. The universal interface as claimed in claim 20, wherein when the PSTN is 4-wire service the relay switch is turned on to maintain the data paths created by the switching unit to the first extended device.

24. In a terminal device comprising a first line interface and a second line interface connected in parallel for a public switched telephone network (PSTN), a method of universally interfacing with the PSTN and at least one extended device, comprising:
detecting a type of the PSTN based on whether the PSTN is a 2-wire system or a 4-wire system; and
selectively switching the second line interface to create a data path from the PSTN to the at least one extended device based on the detected PSTN type.

25. The method as claimed in claim 24, wherein when the detected typed of the PSTN is a 4 wire system, the selectively switching the second line interface comprises connecting pairs of data lines in the second line interface to form a loop from one data line of the first line interface to another data line of the first line interface so that the data path is created from the PSTN to the at least one extended device.

26. The method as claimed in claim 24, wherein when the detected type of the PSTN is a 2-wire system, the selectively switching the second line interface comprises creating the data path from the PSTN through the first line interface and passing through the second line interface to the at least one extended device and switching off any unused data lines.

27. The method as claimed in claim 26, wherein pairs of the data lines of the second line interface are connected to a first extended device and a second extended device.

28. A universal interface for a public switched telephone network (PSTN) terminal device, comprising:
a first line interface connectable to either the PSTN or the PSTN and a first extended device;
a second line interface which connects in parallel with the first line interface by data lines; and
a first jumper and a second jumper which selectively connect the data lines in the second line interface,
wherein when the first line interface is connected to the PSTN and the first extended device, the first jumper connects two of the data lines in the second line interface and the second jumper connects two other of the data lines in the second line interface to create data paths from the PSTN to the extended device through the first line interface and the second line interface, and when the first line interface is connected to only the PSTN, the first and second jumpers are removed to allow the data paths to pass through the second line interface to a second and/or a third extended device.

29. The universal interface as claimed in claim 28, wherein a manufacturer installs the universal interface in the terminal device regardless of an intended product destination to reduce manufacturing costs.
